(19) United States
(12) Patent Application Publication
(10) Pub. No.: US 2014/0059579 A1
(43) Pub. Date: Feb. 27, 2014

(54) SYSTEMS AND METHODS FOR PROJECTING VIEWERSHIP DATA

(71) Applicant: Rentrak Corporation, Portland, OR (US)

(72) Inventors: Michael Vinson, Piedmont, CA (US); Bruce Goerlich, Forest Hills, NY (US); Amir Yazdani, Portland, OR (US); Maria Loper, Portland, OR (US)

(21) Appl. No.: 13/973,282

(22) Filed: Aug. 22, 2013

Related U.S. Application Data
(60) Provisional application No. 61/691,924, filed on Aug. 22, 2012.

(51) Int. Cl. H04N 21/442

(52) U.S. Cl. CPC H04N 21/44204
USPC 725/14

(57) ABSTRACT

Various systems and methods for generating and augmenting viewership datasets are disclosed. In particular, some embodiments prepare the datasets for further analysis by supplementing missing information based upon available data. The system may organize viewership data from disparate formats into a unified form to facilitate analysis and projection of non-reporting device data. In some embodiments, the projections may scale existing cumulative determinations based on information regarding the presence and character of non-reporting devices in different geographic markets.

### CROSS-REFERENCE TO RELATED APPLICATIONS

This application claims priority to and the benefit of U.S. Provisional Application 61/691,924, entitled SYSTEM AND METHOD FOR PROJECTING TELEVISION USER BEHAVIOR, filed on Aug. 22, 2012.

### BACKGROUND

Many stakeholders, e.g. advertisers, television networks, and content providers, desire accurate viewership information so that they may tailor their content and future programming. Such data may arise from a plurality of sources and may take many different forms. Additionally, the data may be managed by a variety of different services, operators, and technology providers, who may each manage the data in a different manner. Coordinating data collection across all of these different entities and preparing the data for a meaningful analysis can be extremely challenging. For example, data on different distribution channels may take different forms, may be reported at different rates, and may satisfy different minimum reporting criteria. Data may come from television set-top boxes (STBs), or equivalent hardware built into a television or other viewing device, and may include data from every channel change, DVR event, or user interaction.

Accordingly, there exists a need for systems and methods to coordinate data collection and formatting from disparate content distribution sources. Supplementing lacunae in the collected data and making meaningful predictions about its content is critical if stakeholders are to have the information they need at an appropriate time and in an appropriate manner, to take action.

### BRIEF DESCRIPTION OF THE DRAWINGS

Example aspects of various of the disclosed embodiments are illustrated in the figures. The examples and figures are illustrative rather than limiting.

FIG. 1 illustrates a data collection topology for receiving and processing media viewership data as can be used in some embodiments.

FIG. 2 is a schematic diagram depicting a sampled household in some embodiments.

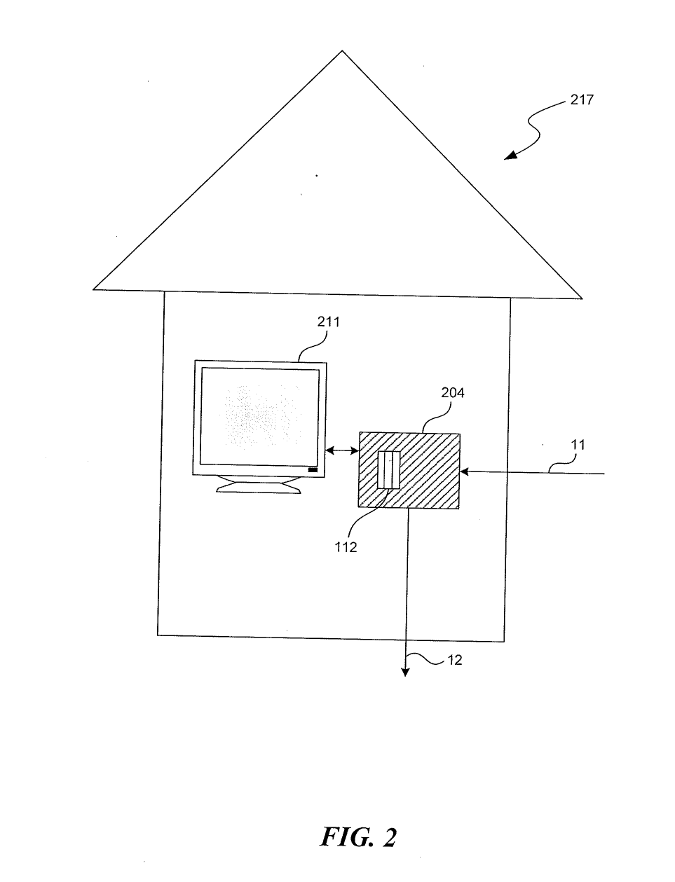

FIG. 3 is a schematic diagram depicting another embodiment of a projection system as implemented in some embodiments.

FIG. 4 is a generalized process flow diagram illustrating various steps in a data analysis process as implemented in some embodiments.

FIG. 5 depicts tune information as received in some embodiments.

FIG. 6 depicts schedule information as received in some embodiments.

FIG. 7 depicts subscriber information as received in some embodiments.

FIG. 8 depicts the overlaying of schedule information as applied in some embodiments.

FIG. 9 depicts an example of tuning data before and after length filtering as performed in some embodiments.

FIG. 10 depicts an example method for supplementing tuning data with operator subscriber information as implemented in some embodiments.

FIG. 11 depicts tuning data summarized by ZIP code and by viewership market as implemented in some embodiments.

FIG. 12 depicts a generalized perspective of viewership projection as implemented in some embodiments.

FIG. 13 depicts a geographic market break-down across the United States as referred to in some embodiments.

FIG. 14 depicts a Digital Broadcast Satellite (DBS) viewing data projection topology as implemented in some embodiments.

FIG. 15 depicts a Cable viewing data projection topology as implemented in some embodiments.

FIG. 16 depicts an Over-The-Air (OTA) viewing data projection topology as implemented in some embodiments.

FIG. 17 depicts an Internet Protocol TV (IPTV) viewing data projection topology as implemented in some embodiments.

FIG. 18 depicts an aggregated data projection topology as implemented in some embodiments.

FIG. 19 depicts the irregular reporting times of various operators as received at a system in some embodiments.

FIG. 20 illustrates a data flow diagram for preparing viewing data to account for missing data for use in a projection estimation as implemented in certain embodiments.

FIG. 21 illustrates a high level topology of a data processing architecture to determine a per market distribution of network viewership as implemented in some embodiments.

FIG. 22 shows a diagrammatic representation of a machine in the example form of a computer system within which a set of instructions may be executed for causing the machine to perform any one or more of the methodologies discussed herein.

Those skilled in the art will appreciate that the logic and process steps illustrated in the various flow diagrams discussed below may be altered in a variety of ways. For example, the order of the logic may be rearranged, substeps may be performed in parallel, illustrated logic may be omitted, other logic may be included, etc. One will recognize that certain steps may be consolidated into a single step and that actions represented by a single step may be alternatively represented as a collection of substeps. The figures are designed to make the disclosed concepts more comprehensible to a human reader. Those skilled in the art will appreciate that actual data structures used to store this information may differ from the figures and/or tables shown, in that they, for example, may be organized in a different manner; may contain more or less information than shown; may be compressed and/or encrypted; etc.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

### System Overview

Embodiments of the present disclosure include systems and methods for upload and/or download streaming encryption to/from an online service, or cloud-based platform or environment.

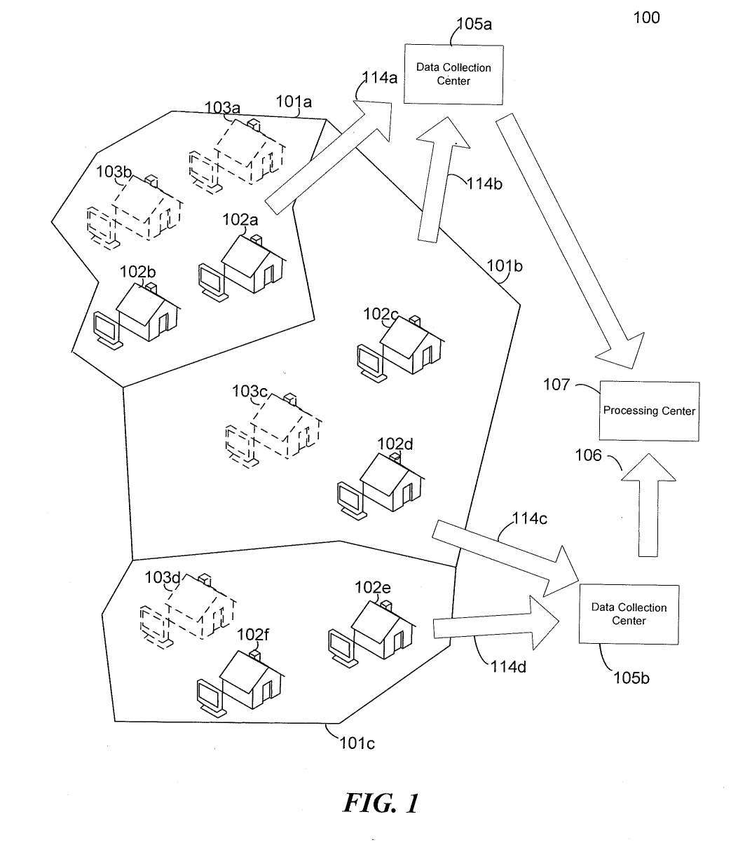

FIG. 1 illustrates a data collection topology 100 for receiving and processing media viewership data as can be used in some embodiments. Several geographic markets 101a-c each contain a plurality of households 102a-f and 103a-d. Individual, per-market data may be available for some households 102a-f but not for others 103a-d. For example, devices within households 103a-d may be unable to report their viewership or their reported viewership may not be available. Though referred to by household for ease of description, one will recognize that a single household may contain both reporting and non-reporting devices, and devices for which data is available and devices for which data is not available. The reporting households send data 114a-d to one or more data collection centers 105a-b. The one or more data collection centers 105a-b then provide the data 106 to a processing center 107.

As used herein, a “household” (HH) refers to a unit of residence (or other viewing location, such as a business location, where viewing devices are available). A “reporting HH” refers to a household in which there are one or more reporting devices, (referred to generally as set top boxes or STBs, though the reporting device need not literally be a box in communication with a viewing device) that return tune data. The “tunes” can be represented as data records, that identify specific user interactions, e.g. channel changes, DVR usage, etc., with a television or other viewing device. In some embodiments, these data records include the following data: one or more unique identifiers of the STB and/or the HH (e.g., if the tune data only identifies the STB, then the operator may also provide mapping of STBs to HHs); one or more date/time stamps (e.g., one date/timestamp for the start of the tune, one date/time stamp for the end); and one or more content identifiers (such as a channel number, network name, etc.). One will recognize that an STB may refer to a set top box physically located outside a display device, software and/or firmware within a device (e.g., a program monitoring browser requests in a desktop computer), or a hardware module within the device, etc. As used herein, an STB represents any device reporting tune data.

Ideally, individual per-market data would be available for each household in each market. Unfortunately, technical, contractual, and organizational limitations often prevent making such data available to a processing center 107. Various of the disclosed embodiments must then infer a per-market distribution of network subscriptions. Accordingly, as used herein, a “non-reporting HH” refers to a household from which there is no tune data readily available. Some embodiments estimate the viewing data from the non-reporting HHs (and/or the viewing from non-reporting STBs within reporting HHs, which is referred to herein as “horizontal projection”). Some embodiments then use the tune-level data to calculate viewing hours, average audience, rating, share, and other metrics.

In addition, the reporting HHs can be fundamentally different in their viewing behavior from the non-reporting HHs. For example, in some cases data will not be available from OTA HHs, and yet those HHs are different from cable/DBS/IPTV HHs in the number of channels available to them. Therefore, in some embodiments a projection system will account for behavioral differences between reporting and non-reporting HHs. In some embodiments, the system and method disclosed herein can take measures to account for these differences.

### Example Analysis System

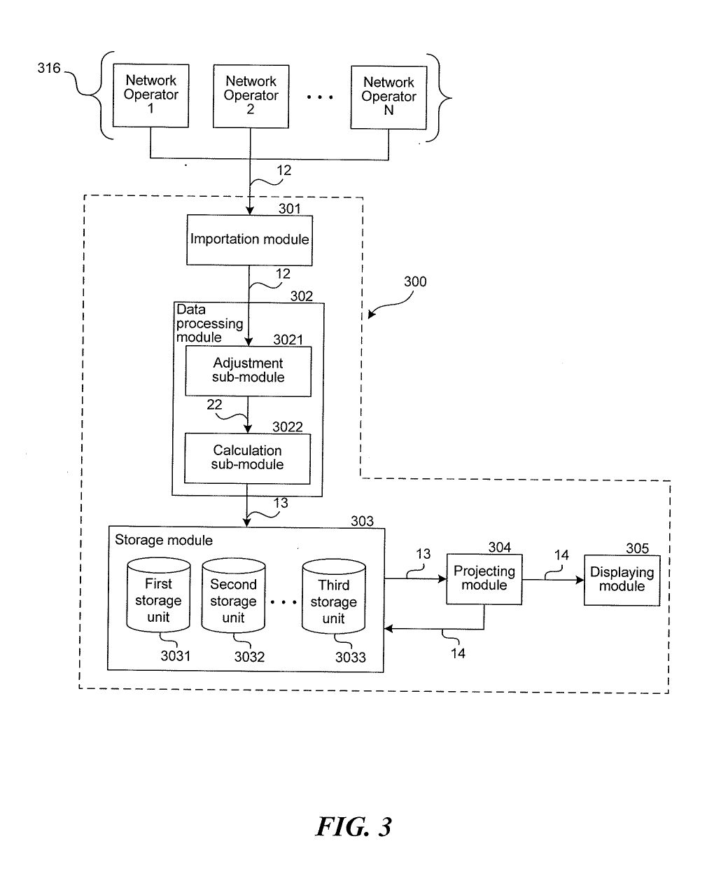

FIG. 3 is a schematic diagram showing an embodiment of a projection system 300. As shown in FIG. 3, the projection system 300 includes an importation module 301, a data processing module 302, a storage module 303, a projecting module 304 and a displaying module 305. In some embodiments, one or more network operators 116 can directly provide sampled household information 12 to the importation module 301 of the projection system 300. The sampled household information 12 relates user behaviors, e.g., selecting and responding to contents 11 from content sources 105. In some embodiments, the sampled household information 12 can include tune data, including a set of subscriber data. The tune data reflects users' behavior for the sampled household 217. The subscriber data show demographic information of the users in the sampled households 217. In some embodiments, the tune data can be combined with schedule data that relates to the playing schedule of the contents 11. In some embodiments, the schedule data can be received as a separate data feed, and can be combined with the tune data by means of network/location/date/time.

The importation module 301 can import the sampled household information 12 to the data processing module 302 for further processing. As shown in FIG. 3, the data processing module 302 can further include an adjustment sub-module 3021 and a calculation sub-module 3022. The adjustment sub-module 3021 can first verify the sampled household information 12 and then adjust information 12 according to the data reliability. In some embodiments, the data reliability can be determined by whether a user turns off the household device 204 when he or she is not actually viewing the contents displayed on the displaying device 211. For example, from empirical studies, around 37% to 55% of users never turn off their household devices 204 for a 24-hour period. This data may show that there is a high likelihood that the users are not watching any programs at least for some period of time (e.g. during the night time), even though the household device 204 is kept on and its record shows that a certain program is accessed. In some embodiments, the criteria to determine whether data from a household device 204 is reliable can include: 1) a household device 204 is reliable if the household device 204 generates at least one power-off event each viewing day; or 2) a household device 204 is reliable if the household device 204 has fewer than 1% of tunes that are six hours or longer. A method and system related to determining when a household device is off is described in more detail in U.S. patent application Ser. No. 13/081,437, entitled “Method and System for Detecting Non-powered Video Playback Devices” and filed on Apr. 6, 2011, which is hereby incorporated by reference in its entirety for all purposes.

Referring back to FIG. 3, after completing the adjustment, the adjustment sub-module 3021 transmits the adjusted sampled household information 22 to the calculation sub-module 3022. The calculation sub-module 3022 then calculates the processed household information 13 based on at least one predetermined factor, including demographic distribution, geographic distribution, or user behavior surveys.

After the calculation, the data processing module 302 can transmit the processed household information 13 to a storage module 303. In some embodiments, the storage module 303 can include several storage units 3031, 3032, and 3033. For example, the storage module 303 can save the processed household information 13 generated from the sampled household information 12 provided by the first network operator in a first storage unit 3031. Similarly, the processed household information 13 generated from the sampled household information 12 provided by the second network operator can be saved in a second storage unit 3032. In addition, all of the processed household information 13 can be saved integrally in an integrated third storage unit 3033. As discussed above, the processed household information 13 includes all of the user behavior information in the predetermined geographic market area 101 during a period of time in some embodiments. In some embodiments, the processed household information 13 can include the viewing rates of certain contents 11, or how long or through which distribution channel 107 or network operator 316 the targeted users access certain contents 11. In some embodiments, the processed household information 13 can be the basis for calculating the projection information 14.

As shown in FIG. 3, the processed household information 13 can be transmitted from the storage module 303 to the projecting module 304. The projecting module 304 can generate the projection information 14 upon a projection request from customers or automatically in some embodiments. In some embodiments, the projection information 14 can include: the viewing rates of contents 11 within a certain area during a certain period of time, users' profile of certain contents 11, users' preference of accessing certain contents 11, or the interrelationship of user behavior among different contents. In some embodiments, the projection information 14 can be customized depending on customers' requests. In some embodiments, the projection information 14 can also be saved in the storage module 303.

As shown in FIG. 3, the system 300 can further include a displaying module 305. In some embodiments, the displaying module 305 can display the projection information 14 by electronic documents, hardcopy reports, images files, or tables or charts displayed on a user interface.

### Analysis Process

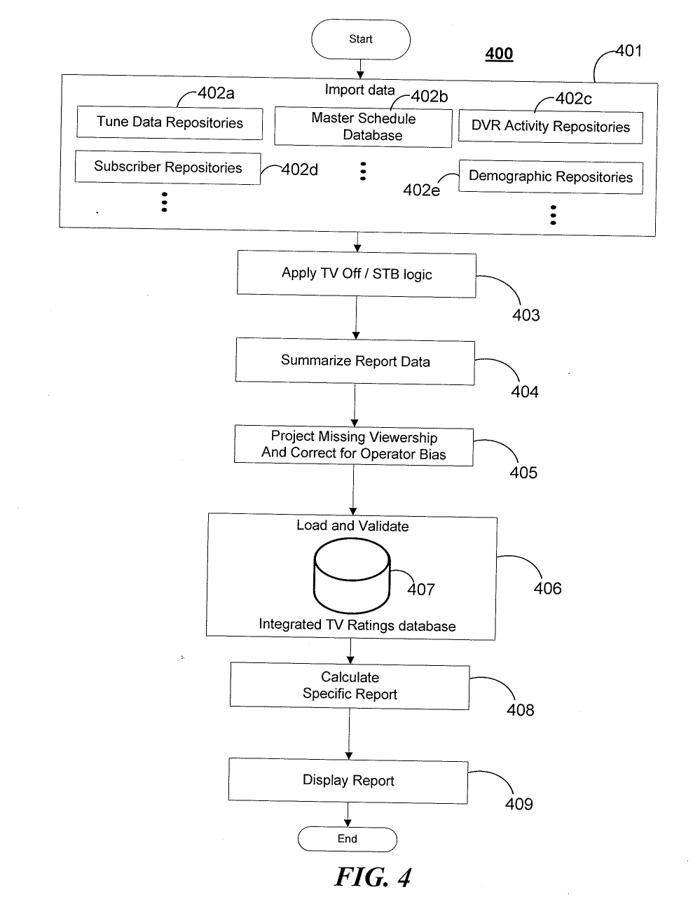

FIG. 4 is a generalized process flow diagram illustrating various steps in a data analysis process 400 as can be implemented in some embodiments.

In some embodiments, the data imported at block 401 can include tune data repositories 402a, a master schedule database 402b depicting content display times, DVR Activity Repositories 402c including DVR viewing data, Subscriber Repositories 402d including HH and/or individual subscriber information, and Demographic Repositories 402e including information regarding populations located in respective markets. Additional or fewer repositories may be included in some embodiments depicting different data.

The system may apply TV off/Set Top Box logic at block 403 to the imported data. For example, the system may generate survival curves and/or identify invalid tuning data.

At block 404, the system may summarize a report of the data.

At block 405, the system may project missing viewership and correct for operator bias. Some methods for projecting viewership are described in greater detail below.

At block 406, the system may load and validate the data, e.g., into an integrated TV rating database 407. Though referred to as a “TV ratings database” one will recognize that the database may include general content information, such as information for content distributed via websites, Video On Demand (VOD), pay-per-view, etc., and may include both live viewing and DVR recording and playback.

At block 408, the system may calculate a specific report detailing features and characteristics desired by a stakeholder.

At block 409, the system may provide the report to an analyst for review.

### Tune Information

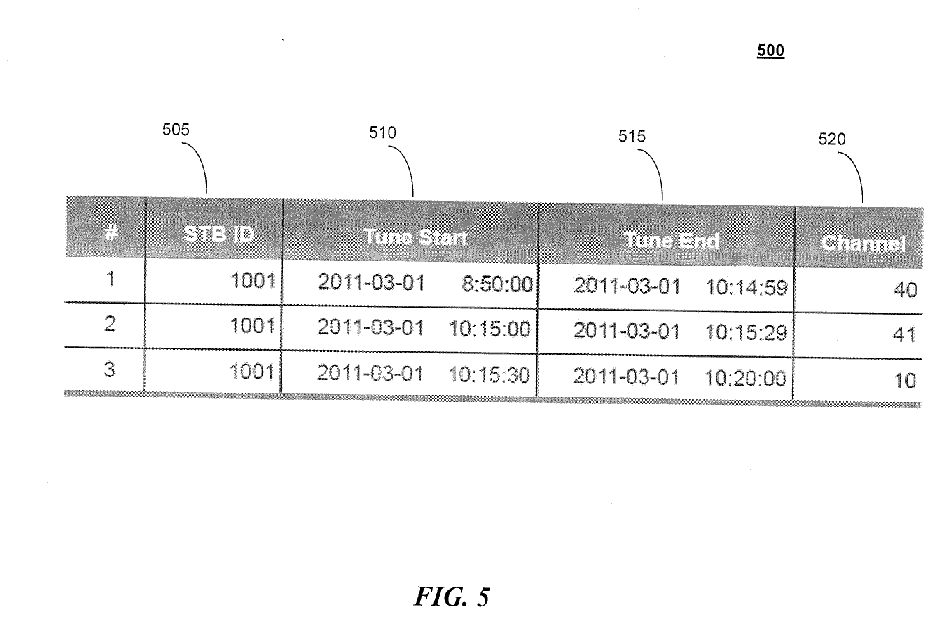

FIG. 5 depicts tune information 500 as received in some embodiments. The information 500 can include a “set top box” ID 505, a “tune start” timestamp 510, a “tune end” timestamp 515, and a channel indicator 520 (or other content address, e.g. a URL).

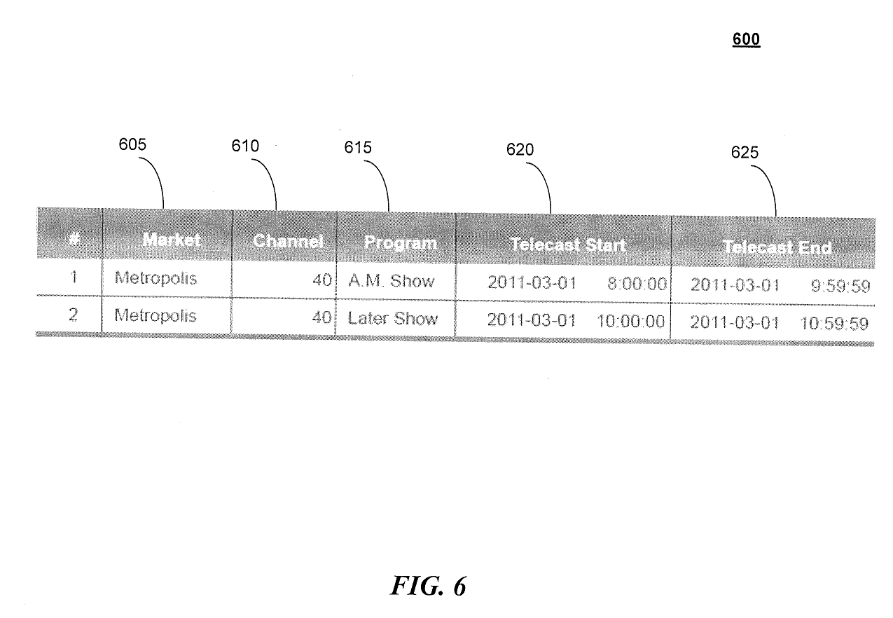

FIG. 6 depicts schedule information 600 as received in some embodiments. The information 600 can include a market 605, channel 610, program 615 (or similar content identification), and a “telecast start” timestamp 620, and a “telecast end” timestamp 625. “Telecast” as used herein refers not only to radio and television broadcasts, but to the viewing of content generally, such as when it is delivered upon request by a user, e.g., via download.

### Subscriber Information

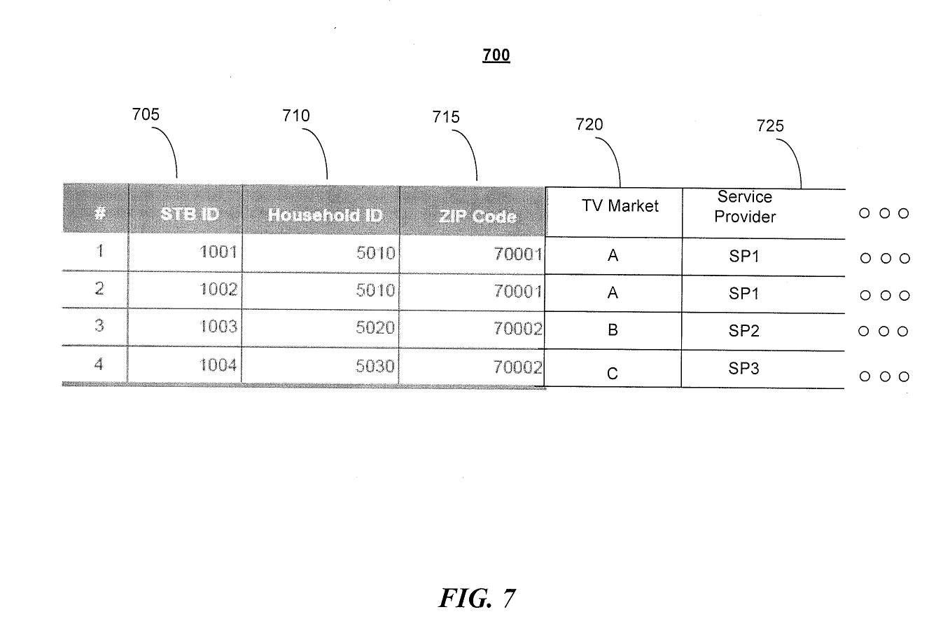

FIG. 7 depicts subscriber information 700 as received in some embodiments. The information 700 can include a STB ID 705, a household ID 710, and a zip code 715. One will recognize that the particulars of these examples can be varied (e.g., a market identifier rather than a zip code may be provided). In some embodiments, information for TV Markets 720 and service providers 725 can also be provided.

### Tune Data Post-Processing: Overlaying Schedules on Tune Information

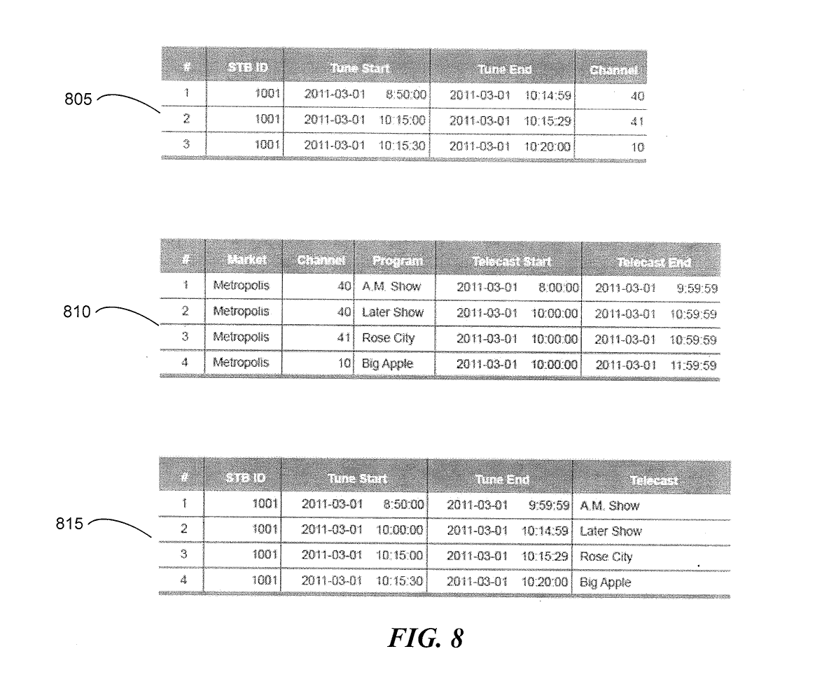

FIG. 8 depicts the overlaying of schedule information as applied in some embodiments. The system may receive tune data 805 and schedule information 810. By overlaying the schedule information 810 on the tune data 805 that channel can be replaced with the telecast aired by the operator as depicted in combined data 815.

### Tune Data Post-Processing: Filtering

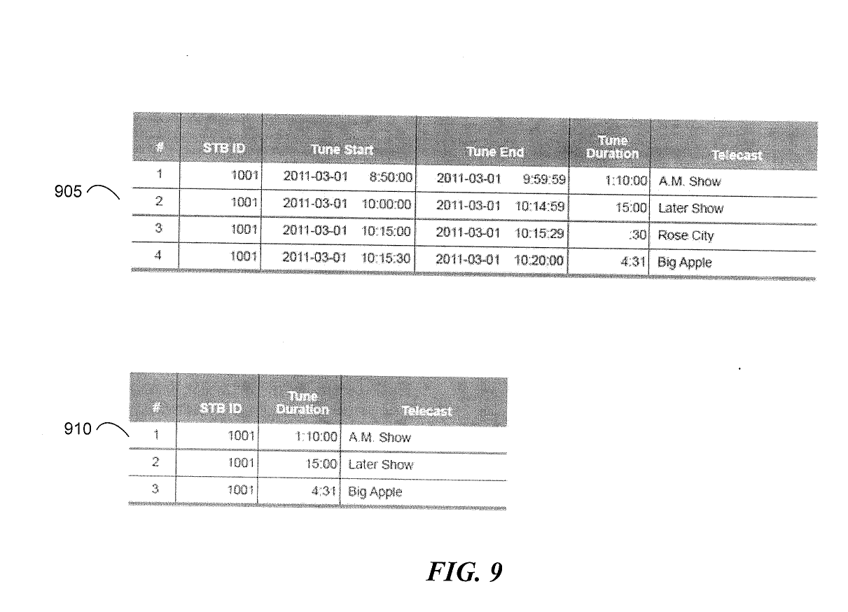

FIG. 9 depicts an example of tuning data before and after length filtering as performed in some embodiments. Initially, the tune data entries 905 comprise both tune start and end times. Following processing the entries appear in reduced form 910. As row 3 comprises less than a 30 second duration, the system may remove the entry.

### Operator Information

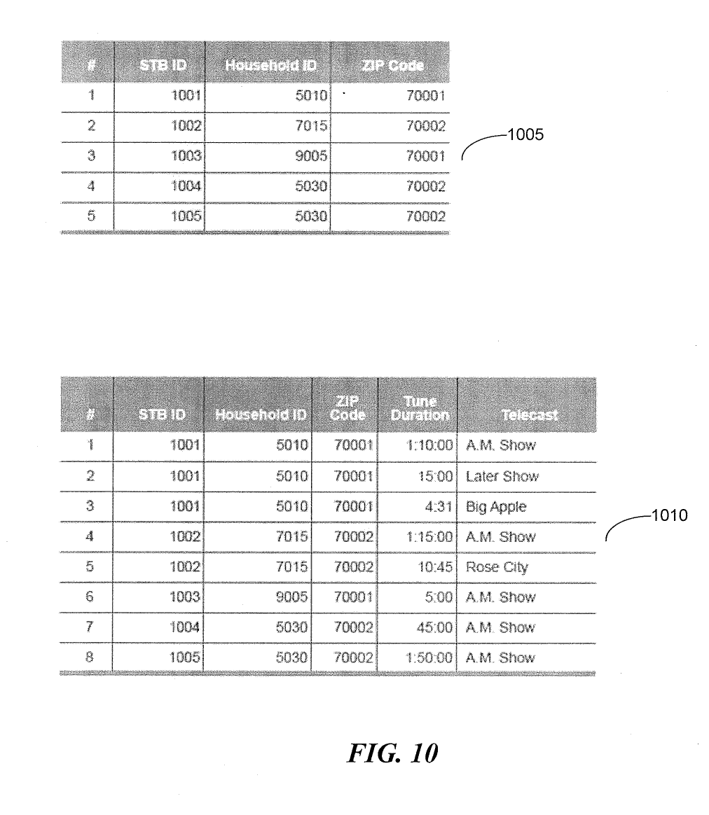

FIG. 10 depicts an example method for supplementing tuning data with operator subscriber information as implemented in some embodiments. Initial operator subscriber information 1005 may be paired with tune data based on the STB ID, e.g. reduced form 910, to create composite entries 1010.

### Data Summarization

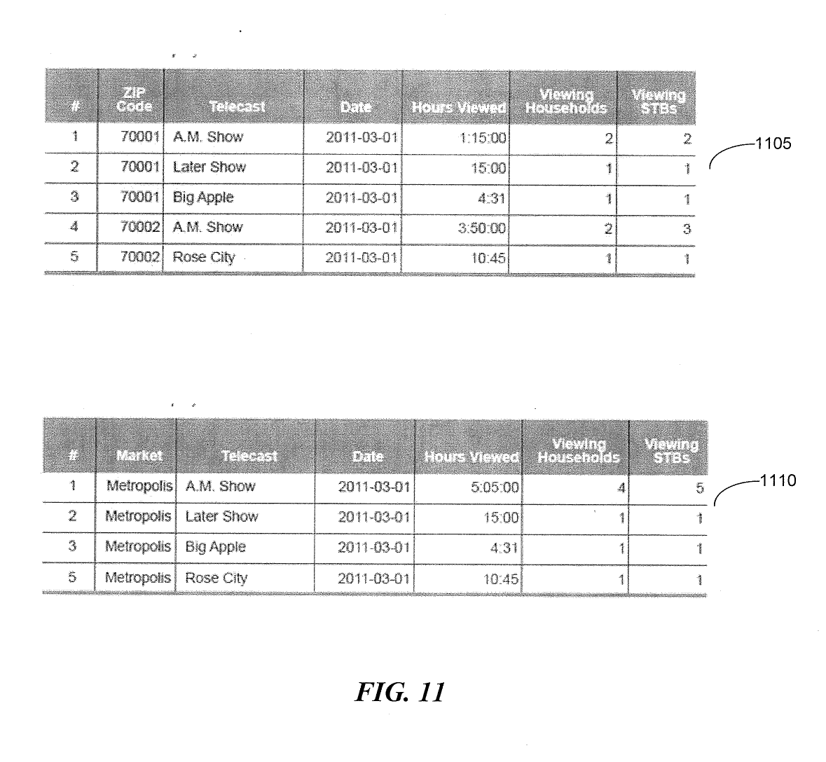

FIG. 11 depicts tuning data summarized by ZIP code and by viewership market as implemented in some embodiments. The system may take the composite entries 1010 and calculate telecast viewing information within a ZIP code. For example, the system may take viewership data organized by zip code 1105 and reorganize the data by market 1110. In row 4 of data organization 1105, there are three STBs that viewed the “A.M. Show”, but only two HHs are depicted as viewing the “A.M. Show”. This indicates that there are two STBs in household 5030 tuned to the same telecast.

### Viewership Projection

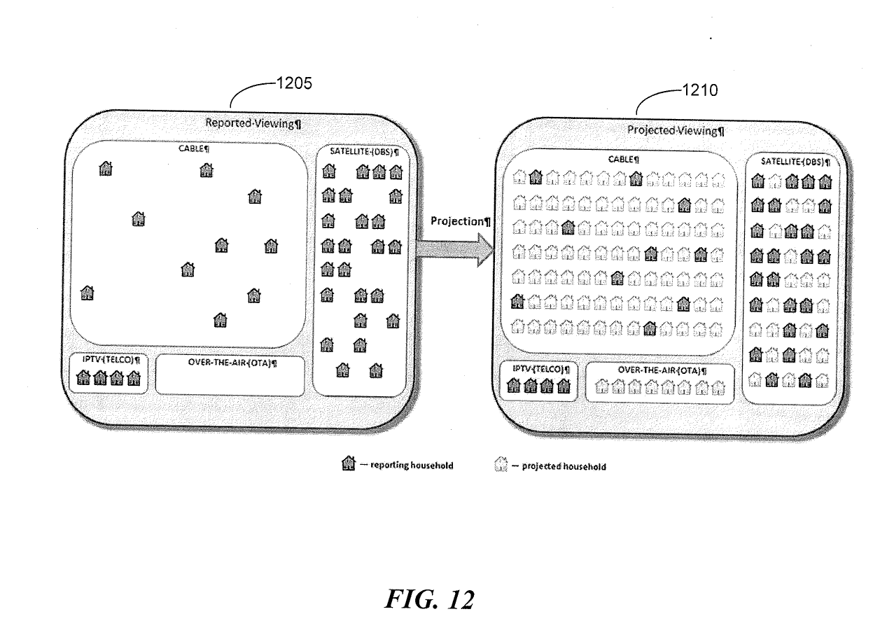

FIG. 12 depicts a generalized perspective of viewership projection as implemented in some embodiments. The reported data 1205 may include some information for each reporting household in the different strata (e.g., cable, IPTV, OTA, Satellite, etc.). However, each stratum may contain a plurality of non-reporting households, or households for which data is not yet available. Accordingly, the system may project data based, in part, upon the reporting households to produce projected viewing data 1210.

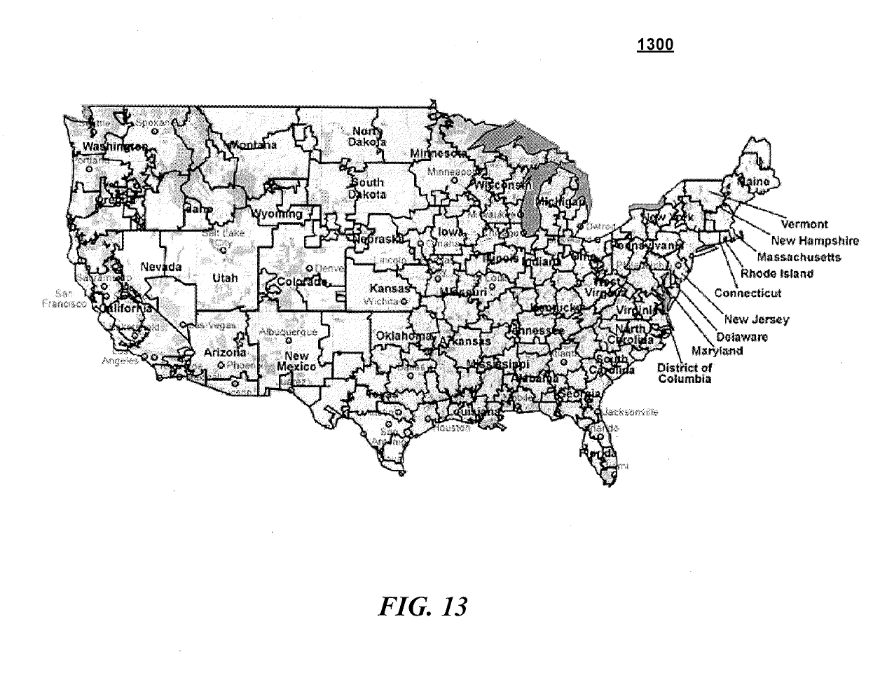

FIG. 13 depicts a geographic market break-down 1300 across the United States as referred to in some embodiments.

In some embodiments, the system gathers viewing information from operator partners in each of the 210 U.S. television market areas. The system may receive data from various network operators, e.g., Dish Network®, AT&T's U-verse Digital TV®, Charter Communications®, etc. In some embodiments, the system collects viewing information from reporting households using multiple network operators (e.g., cable television; direct broadcast satellite (DBS); Internet Protocol TV (IPTV), sometimes referred to as telco; over-the-air (OTA) households). These different information sources are referred to herein as “strata” though this should not imply a partial or total ordering of the sources. In some embodiments, for each of the 210 TV markets, the projection system uses information that was reported to model the viewing households that were not reported. The system can roll up the 210 markets to produce national measurements. In some embodiments, for each market, the projection system can project DBS viewing, cable viewing data, OTA viewing data, IPTV viewing data, and can aggregate these four strata.

In some embodiments, data from each stratum may have its own considerations and its own challenges. For example, in some embodiments DBS data is estimated based only on a single operator's (e.g., Dish®) viewing data (on the assumption that satellite HHs are more similar to each other than to other reporting operators). In some embodiments telco data may likewise only include data from a single operator (e.g., AT&T®). In some embodiments, cable data is based on the observed viewing on cable HHs from reporting cable operators (e.g., Charter®), or from another data source such as a national survey. In some embodiments, OTA factors can be estimated from a national survey, since it may be that no OTA HH reports STB data.

### Viewership Projection—Projecting DBS Data

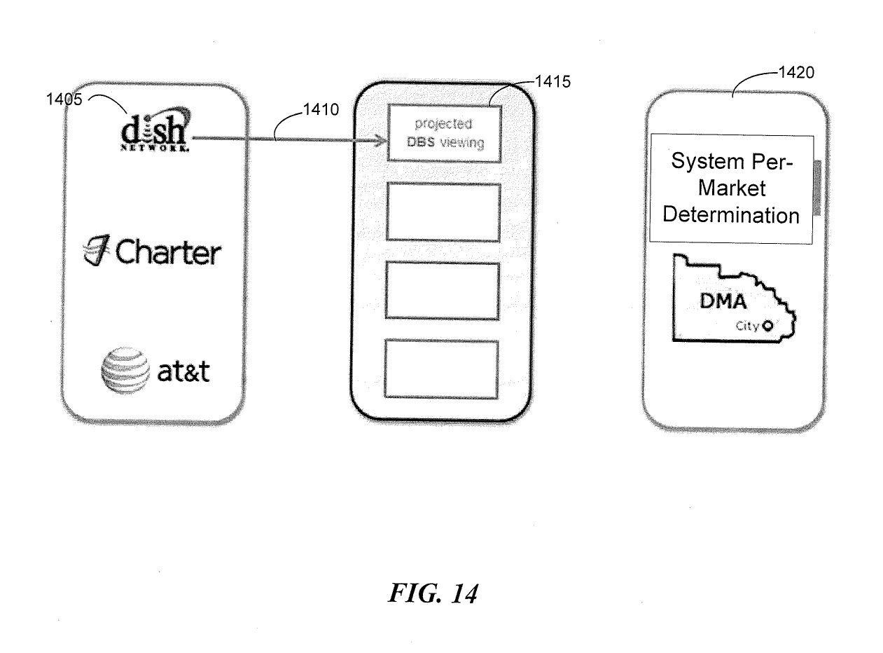

FIG. 14 depicts a DBS viewing data projection topology as implemented in some embodiments. One will recognize each of the “dish network”, “Charter”, and “at&t” symbols of FIGS. 14-18 are registered trademarks of their owners (DISH Network L.L.C., Charter Communications, Inc., and AT&T Intellectual Property and/or AT&T affiliated companies), and appear here merely as examples of possible reporting operators as used in some embodiments. In some embodiments, because dish households provide a better basis for estimating DBS viewing data. Accordingly, only households from the Dish dataset 1405 are used for the projection 1410 to create the projected DBS viewing data 1415 in some embodiments.

### Viewership Projection—Projecting Cable Data

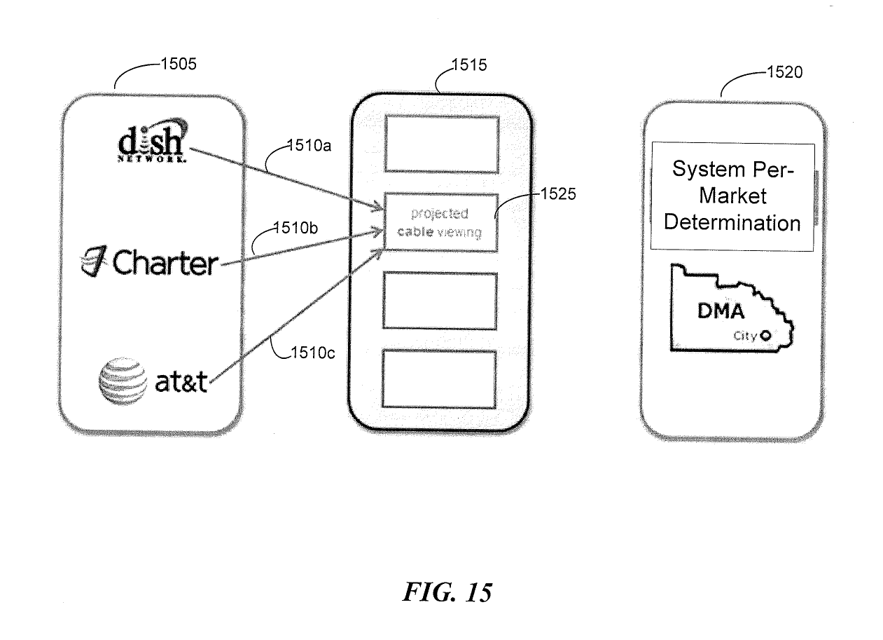

FIG. 15 depicts a Cable viewing data projection topology as implemented in some embodiments. In some embodiments, data 1510a-c from each of the available strata datasets can be used to created projected cable viewing data 1525.

In some instances, cable households may watch some networks more than DBS and IPTV households do. Conversely, the cable households may also watch some networks less than DBS and IPTV households. Some embodiments use viewing information from cable operators to adjust the reported viewing of DBS and IPTV households to account for these viewing differences. The system may supplement the cable viewing information, e.g., with a consumer survey. The adjustments can be made on a network-by-network basis in some embodiments. Various factors or other statistical adjustments may be applied to account for differences among different type of television service and consequent viewer behavior. In some embodiments, a factor that represents the ratio of viewing hours per HH in non-reporting cable stratum HHs to viewing hours per HH in reporting HHs can be inferred from another data source or from a national survey. In some embodiments, for cable and DBS, the projection system can account for variances between the reporting operators' network coverage and the projected stratum's network coverage. One example of a process may proceed as follows.

First, the system may calculate the rating among reporting households. For example, suppose that the reported viewing of a particular piece of content (a network, station, telecast, etc.) over a given period of time for the households shows a rating value of 1.5% (meaning that on average during the time period in question, 1.5% of the total HHs are watching the given content).

Second, the system may apply the operators' network coverage. The system may calculate a “coverage rating”, which measures viewing among only the reporting households that can view the network (e.g. that are subscribers of the network). For example, suppose that 80% of the reporting households carry a subscription to the network. In this example:

Coverage Rating=1.5%/0.80=1.875%

For example, if fewer households carry subscriptions, the coverage rating will increase to reflect the greater weight of those households. Conversely, if more households carry the subscription, the coverage rating will increase less. If all households carry the subscription, then the rating will not change.

Third, the system may apply the stratum's network coverage. The projection system can apply the coverage rating, 1.875%, to all of the market's covered cable households or covered DBS households. For example, the system may assume that 1.875% of the stratum households that can watch the network do watch the network (during the time period in question). If 60% of all households in the stratum carry a subscription to the network then:

Projected Rating=1.875%*0.60=1.125%

### Viewership Projection—Projecting OTA Data

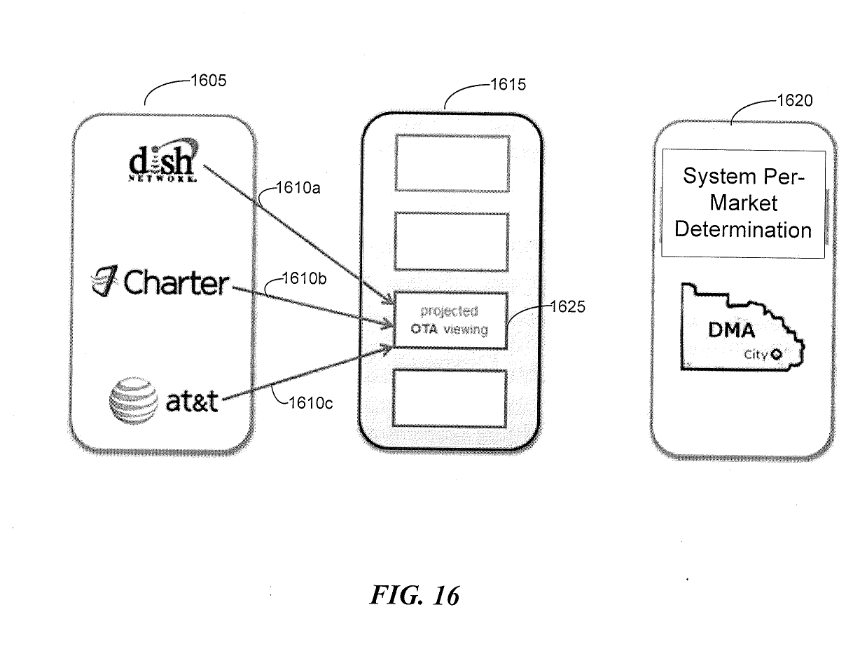

FIG. 16 depicts an Over-The-Air (OTA) viewing data projection topology as implemented in some embodiments. In some embodiments, data 1610a-c from each of the available strata datasets can be used to created projected cable viewing data 1625.

In some embodiments, the system may not have direct reporting from OTA households, but may still recognize that OTA households watch TV differently from DBS, IPTV, and cable households. For example, the OTA households may watch some networks more and some networks less than other strata. Some embodiments use a consumer survey to adjust for these viewing differences on a network-by-network basis. Various factors or other statistical adjustments may be applied to account for differences among different types of television service and consequent viewer behavior. In some embodiments, a factor that represents the ratio of viewing hours per HH in non-reporting OTA stratum HHs to viewing hours per HH in reporting HHs can be inferred from another data source or from a national survey.

In addition, in some embodiments, because OTA households can watch only the handful of broadcast channels, reported viewing for those channels receives more effective weight when OTA viewing is projected. For example, the system can assign all reported viewing hours on non-broadcast networks to the broadcast networks.

### Viewership Projection—Projecting IPTV Data

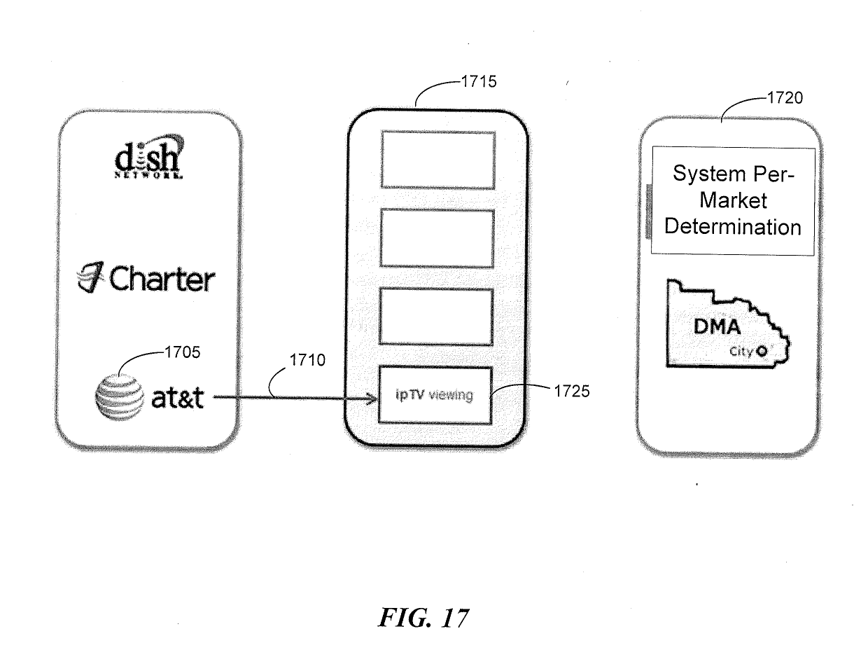

FIG. 17 depicts an IPTV viewing data projection topology as implemented in some embodiments. In some embodiments, such as the one depicted in FIG. 17, the IPTV stratum consists only of data 1710 from one source 1705, e.g. AT&T®. Accordingly, the projection 1725 may be based exclusively on this data.

### Viewership Projection—Aggregating Strata

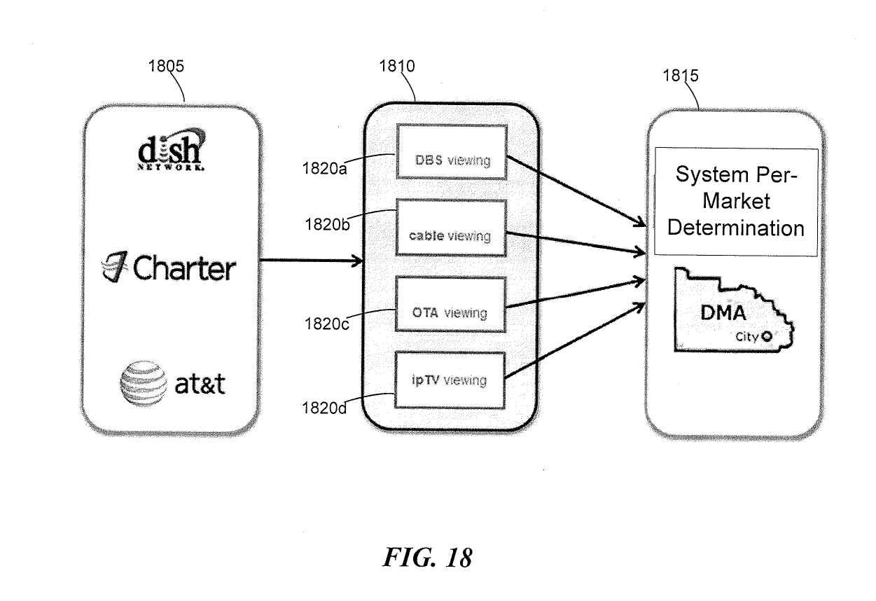

FIG. 18 depicts an aggregated data projection topology as implemented in some embodiments. Once projection data 1820a-d has been prepared for each strata, the system may integrate the projection data to produce a per-market determination of viewership 1815.

In this step the system can add up the viewing from all four strata, for which data has already been estimated.

### Data Pre-Processing Operations

### Data Pre-Processing Operations—Incomplete Reporting

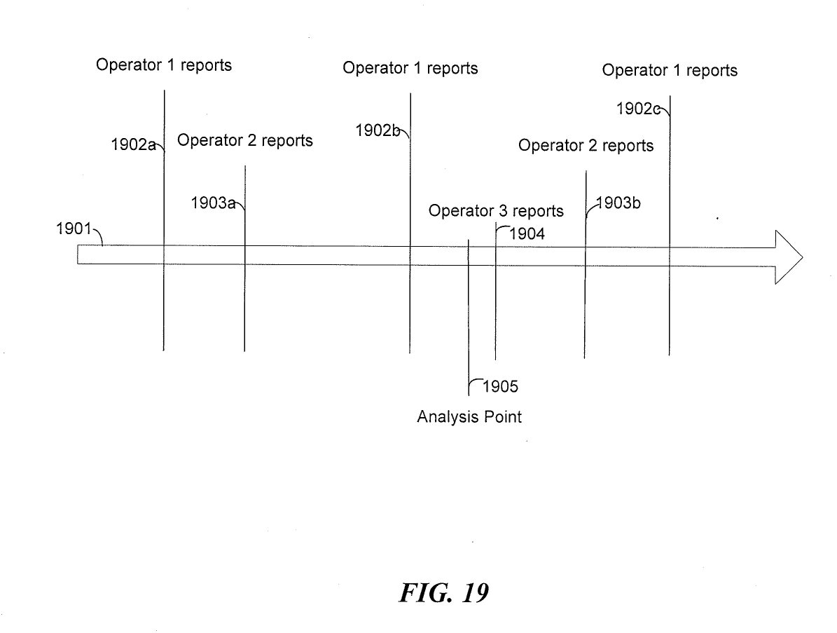

FIG. 19 depicts the irregular reporting times of various operators as received at a system in some embodiments. As time 1901 progresses, Operator 1 may report at times 1902a-c, Operator 2 may report at times 1903a-b, and Operator 3 may report at time 1904. Accordingly, if an analysis is to be performed at time 1905, the processing center may need to estimate the data in the reports at times 1904, 1903b, and 1902c.

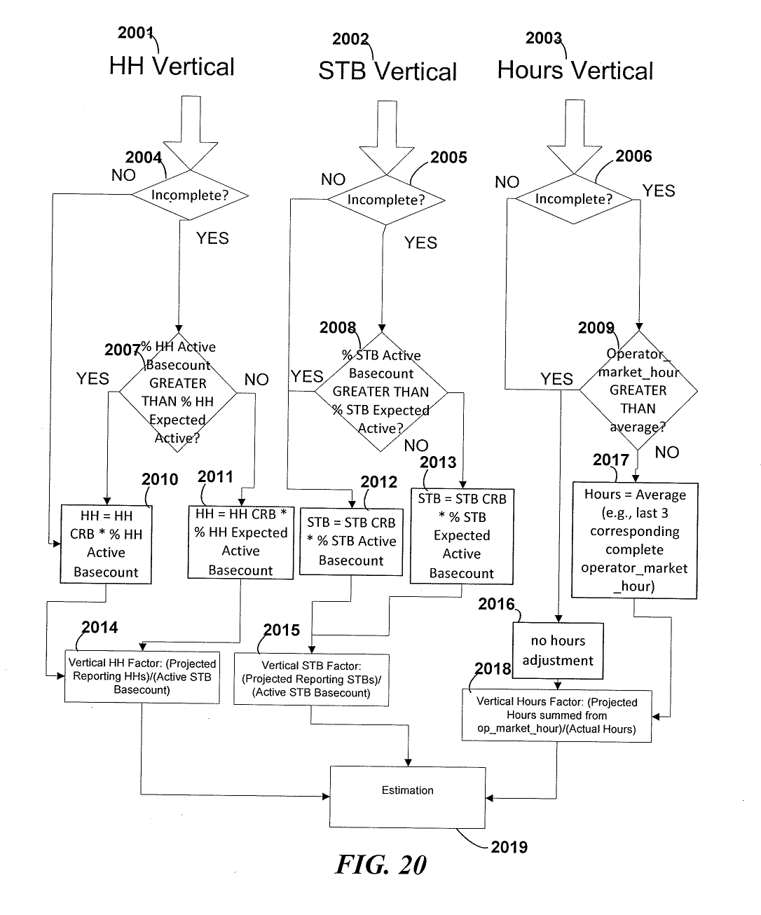

FIG. 20 illustrates a data flow diagram for preparing viewing data for use in a projection estimation as implemented in certain embodiments. The system may rely on an “expected number” of reporting HHs, STBs, and/or viewing hours, and may adjust for a shortfall by scaling up the reported viewing by the ratio of expected to actual HHs, STBs, and/or hours.

In the example of FIG. 20, a three-factor vertical projection is depicted employing data from a Household (HH) vertical 2001, Set-Top-Box (STB) vertical 2002, and Hours vertical 2003. In some embodiments, incomplete projection of HHs and STBs can be calculated at the level of the report day, week or month by each market/operator. A final projection value can be rolled up across market/operator

In some embodiments, incomplete projection of Hours is calculated at the hour level by market/operator. The projected number of hours can be rolled up to the level of the report.

In some embodiments all HH reporters are configured to report HHs that have fully reported all data for the period. In some embodiments, DISH data can be provided 14 days after the system has processed the first file from date.

In some embodiments, the Vertical HH Factor 2001 can include the projected number of HHs that take place at the level of the report (day, week, or month) and can be calculated by the market/operator. In some embodiments, all market/operator reports can roll up the number of projected HHs by market. In this manner, the operator can give the projected total number of HHs (HH Vertical Factor).

Where the HH data is complete 2004, the projected Reporting HHs for the Vertical HH Factor 2001 can be (HH CRB*% HH Active Basecount) as indicated at block 2010.

In some embodiments, when the HH data is incomplete 2004 the system can determine if % HH Active Basecount GREATER THAN % HH Expected Active at block 2007. If so, HH can be set to be (HH CRB*% HH Active Basecount) at block 2010.

In contrast, if % HH Active Reporting LESS THAN % HH Expected Active, HH can be set to (HH CRB*% HH Expected Active Basecount) at block 2011. At block 2014 the system can then scale the Vertical HH Factor: (Projected Reporting HHs)/(Active STB Basecount).

With regard to the Vertical STB Factor 2002, the projected number of STBs can take place at the level of the report (day, week, or month) and can be calculated by market. In some embodiments, the lowest level this projection takes place at the market day. The market day factor can then be applied to all lower level reports.

Where the complete STB data is available 2005, STB can be set as (STB CRB* % STB Active Basecount) at block 2012. Where the STB data is incomplete 2005 the system can determine if % STB Active Basecount GREATER THAN % STB Expected Active at block 2008. If this is true, the system can set the STB value to (STB CRB*% STB Active Basecount) at block 2012.

In contrast, if the condition is false, e.g. if % STB Active Reporting LESS THAN % STB Expected Active, the system can set STB to (STB CRB*% STB Expected Active Basecount) at block 2013. At block 2015 the system can then scale the Vertical STB Factor: (Projected Reporting STBs)/(Active STB Basecount).

With regard to the Vertical Hours Factor 2003, the projection of Hours can take place at the operator_market_hour. An operator_market_hour can include the CTRB of the reported hours in some embodiments. In some embodiments, factors can be applied to the operator_market_network_hour and rolled up to the appropriate level of reporting.

In some embodiments, when determining the Projected Reporting Hours, where the data is complete at block 2006 the system can make no adjustment to hours at block 2016.

If instead, the data is incomplete, the system can determine if operator_market_hour is GREATER THAN the average (e.g., of the last 3 corresponding complete operator_market_hours) at block 2009. If this is the case, then no hours adjustment occurs at block 2016.

If instead the operator_market_hour LESS THAN average (e.g., of the last 3 corresponding complete operator_market_hour), then the hours are set to the average(last 3 corresponding complete operator_market_hour) at block 2017.

At block 2018 the system can then scale the Vertical Hours Factor: (Projected Hours summed from op_market_hour)/(Actual Hours).

At block 2019 an estimation of the viewership may be generated based upon the factors.

### Data Pre-Processing Operations—Geographic Distribution

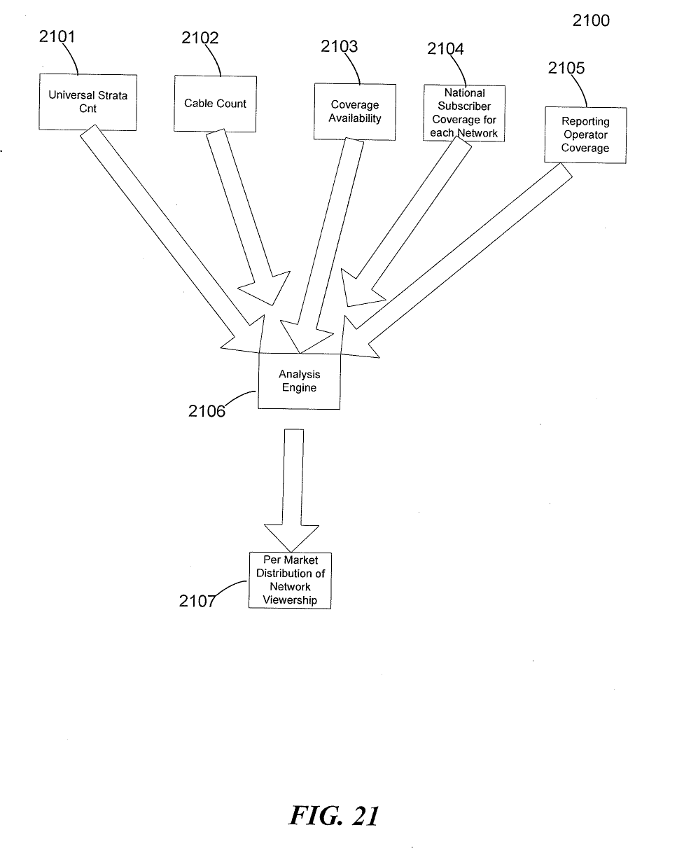

FIG. 21 illustrates a high level topology of a data processing architecture to determine a per market distribution of network viewership as implemented in some embodiments. As discussed with reference to various embodiments herein, an analysis engine 2106 can receive a plurality of data 2101-2105 and produce a per-market distribution of network subscription viewership 2107.

### Computer System

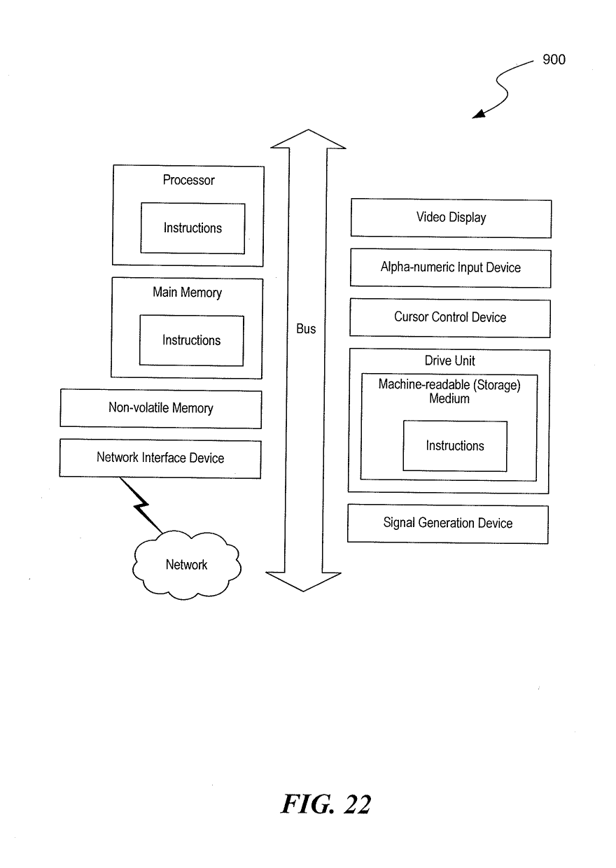

FIG. 22 shows a diagrammatic representation of a machine 2200 in the example form of a computer system within which a set of instructions may be executed for causing the machine to perform any one or more of the methodologies discussed herein.

In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a user device, a tablet PC, a laptop computer, a set-top box (STB), a personal digital assistant (PDA), a cellular telephone, an iPhone, an iPad, a Blackberry, a processor, a telephone, a web appliance, a network router, switch or bridge, a console, a hand-held console, a (hand-held) gaming device, a music player, any portable, mobile, hand-held device, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any non-transitory medium that is capable of storing, encoding or carrying a set of instructions for execution by the machine and that cause the machine to perform any one or more of the methodologies of the presently disclosed technique and innovation.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include, but are not limited to, recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

The network interface device enables the machine 2200 to mediate data in a network with an entity that is external to the host server, through any known and/or convenient communications protocol supported by the host and the external entity. The network interface device can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

The network interface device can include a firewall which can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand.

Other network security functions can be performed or included in the functions of the firewall, can be, for example, but are not limited to, intrusion-prevention, intrusion detection, next-generation firewall, personal firewall, etc. without deviating from the novel art of this disclosure.

### Remarks

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include, but are not limited to, recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further, any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. §112, 16, other aspects may likewise be embodied as a means-plus-function claim, or in other forms, such as being embodied in a computer-readable medium. (Any claims intended to be treated under 35 U.S.C. §112, ¶6 will begin with the words “means for”.) Accordingly, the applicant reserves the right to add additional claims after filing the application to pursue such additional claim forms for other aspects of the disclosure.

What is claimed is:

1. A computer system comprising:
at least one processor;
a memory comprising instructions configured to be executable by the at least one processor to cause the computer system to:
receive a viewership dataset for a plurality of geographic markets, the viewership dataset provided, at least in part, by one or more of a direct broadcast satellite (DBS) operator, cable operator, Over-The-Air (OTA) operator, or Internet Protocol TV (IPTV) operator, and wherein the viewership dataset comprises tuning events associated with a plurality of reporting devices, the tuning events comprising tuning start times and tuning end times;
receive a content schedule, the content schedule depicting start times and end times of content distribution;
determine a survival model based upon at least a portion of the viewership dataset;
adjust a tuning end time in the viewership dataset based on the survival model;
after adjusting a tuning end time, filter the viewership dataset by removing entries having durations below a threshold;
after filtering the dataset, create a content-viewed dataset based on the viewership dataset and the content schedule, the content-viewed dataset indicating the content viewed between the tuning start time and tuning end time;
estimate a number of viewing devices in the geographic markets but which did not report data in the viewership dataset;
project viewing data for the estimated number of viewing devices present in the plurality of geographic markets but which did not report data in the viewership dataset based upon data from operators in the viewership dataset; and
determine, for at least one content, a total time of viewership and a total number of viewing households based, at least in part, upon the projected viewing data.

2. The computer system of claim 1, wherein creating the content-viewed dataset comprises:
overlaying the content schedule upon the tune data and replacing channel information with content information.

3. The computer system of claim 1, wherein the instructions are further configured to be executable by the at least one processor to cause the computer system to:
determine a per-market determination of viewership for the at least one content.

4. The computer system of claim 1, wherein the instructions are further configured to be executable by the at least one processor to cause the computer system to:
calculate a coverage rating by scaling a percentage of households watching a content by a percentage of reporting households carrying a subscription to a network displaying the content.

5. A computer-implemented method comprising:
receiving a viewership dataset for a plurality of geographic markets, the viewership dataset comprising tuning events associated with a reporting device, the tuning events comprising tuning start times and tuning end times;
determining a survival curve based upon at least a portion of the viewership dataset;
adjusting a tuning end time in the viewership dataset based on the survival curve;
projecting data for the number of viewing devices present in the plurality of geographic markets but which did not report data in the viewership dataset; and
determining, for at least one content, a total time of viewership and a total number of viewing households based, at least in part, upon the projected data.

6. The computer-implemented method of claim 5, wherein the viewership dataset comprises data provided, at least in part, by one or more of a direct broadcast satellite (DBS) operator, cable operator, Over-The-Air (OTA) operator, or Internet Protocol TV (IPTV) operator.

7. The computer-implemented method of claim 5, further comprising:
receiving a content schedule, the content schedule depicting start times and end times of content distribution;
adjusting a tuning end time in the viewership dataset based on the survival curve; and
after adjusting a tuning end time, filtering the viewership by removing entries having tuning start time and tuning end time durations below a threshold.

8. The computer-implemented method of claim 7, further comprising:
after filtering the dataset, creating a content-viewed dataset based on the viewership dataset and the content schedule, the content-viewed dataset indicating the content viewed between a tuning start time and tuning end time.

9. The computer-implemented method of claim 7, further comprising:
estimating a number of DBS viewing devices present in the geographic markets but which did not report data in the viewership dataset; and
estimating a number of non-DBS viewing devices present in the geographic markets but which did not report data in the viewership dataset.

10. The computer-implemented method of claim 9, further comprising:
projecting DBS viewing data for the estimated number of DBS viewing devices present in the plurality of geographic markets but which did not report data in the viewership dataset based upon data from DBS operators in the viewership dataset; and
projecting non-DBS viewing data for the estimated number of non-DBS viewing devices present in the plurality of geographic markets but which did not report data in the viewership dataset based upon data from a plurality of operators in the viewership dataset.

11. The computer-implemented method of claim 7, further comprising:
determining a household coverage rating associated with a network by scaling a rating value based on the percentage of reporting households carrying a subscription in the network.

12. The computer-implemented method of claim 11, further comprising:
determining a stratum coverage rating by scaling the household coverage rating by a percentage of households in the stratum carrying a subscription to the network.

13. A computer system comprising:
at least one processor;
a memory comprising instructions configured to be executable by the at least one processor to cause the computer system to:
receive a viewership dataset for a plurality of geographic markets, the viewership dataset comprising tuning events associated with a reporting device, the tuning events comprising tuning start times and tuning end times;
determine a survival curve based upon at least a portion of the viewership dataset;
adjust a tuning end time in the viewership dataset based on the survival curve;
project data for the number of viewing devices present in the plurality of geographic markets but which did not report data in the viewership dataset; and
determine, for at least one content, a total time of viewership and a total number of viewing households based, at least in part, upon the projected data.

14. The computer system of claim 13, wherein the viewership dataset comprises data provided, at least in part, by one or more of a direct broadcast satellite (DBS) operator, cable operator, Over-The-Air (OTA) operator, or Internet Protocol TV (IPTV) operator.

15. The computer system of claim 13, the instructions further configured to be executable by the at least one processor to cause the computer system to:
receive a content schedule, the content schedule depicting start times and end times of content distribution;
adjust a tuning end time in the viewership dataset based on the survival curve; and
after adjusting a tuning end time, filter the viewership by removing entries having tuning start time and tuning end time durations below a threshold.

16. The computer system of claim 15, the instructions further configured to be executable by the at least one processor to cause the computer system to:
after filtering the dataset, create a content-viewed dataset based on the viewership dataset and the content schedule, the content-viewed dataset indicating the content viewed between a tuning start time and tuning end time.

17. The computer system of claim 16, the instructions further configured to be executable by the at least one processor to cause the computer system to:
estimate a number of DBS viewing devices present in the geographic markets but which did not report data in the viewership dataset; and
estimate a number of non-DBS viewing devices present in the geographic markets but which did not report data in the viewership dataset.

18. The computer system of claim 17, the instructions further configured to be executable by the at least one processor to cause the computer system to:
project DBS viewing data for the estimated number of DBS viewing devices present in the plurality of geographic markets but which did not report data in the viewership dataset based upon data from DBS operators in the viewership dataset; and
project non-DBS viewing data for the estimated number of non-DBS viewing devices present in the plurality of geographic markets but which did not report data in the viewership dataset based upon data from a plurality of operators in the viewership dataset.

19. The computer system of claim 13, the instructions further configured to be executable by the at least one processor to cause the computer system to:
determine a household coverage rating associated with a network by scaling a rating value based on the percentage of reporting households carrying a subscription in the network.

20. The computer system of claim 19, the instructions further configured to be executable by the at least one processor to cause the computer system to:
determine a stratum coverage rating by scaling the household coverage rating by a percentage of households in the stratum carrying a subscription to the network.
